(19) United States
(12) Patent Application Publication
(10) Pub. No.: US 2004/0177522 A1
(43) Pub. Date: Sep. 16, 2004

(54) Measuring instrument for bay windows

(76) Inventor: Dingge Xiong, Arcadia, CA (US)

Correspondence Address: Dingge Xiong, 1009 Arcadia Ave. Apt 21, Arcadia, CA, 91007, US

(21) Appl. No.: 10/384,839

(22) Filed: Mar. 11, 2003

(51) Int. Cl. E06B 3/00

(52) U.S. Cl. 33/194

(57) ABSTRACT

A measuring instrument for bay windows is primarily comprised of a left wing and a right wing, and the two wings are joined together by a rivet, and each of them can rotate around the rivet, and each has a straight topside. There are three sets of scale line respectively for the angle, the width and the interval on a surface of the two wings. In which, the interval lines is the most important, and they are a set of parallel lines parallel to the topside to indicate the interval to the topside. The two straight topsides can form an included angle by the rivet as a vertex. The two topsides and each pair of corresponding interval lines can align when the included angle is 180°, but each pair of the corresponding interval lines intersect when the included angle is less than 180°. Make width an indicating line pass through an intersection of some pair of corresponding interval lines, and it can just point out according width value. With the measuring instrument we not only can take an accurate angles of the bay windows or any corner of a room, but also we can easy get the length value (sometimes width value, such as draperies) of those straight lines parallel to the walls to form the included angle. It is very useful in the businesses of interior design and decoration.

### CROSS-REFERENCE TO RELATED APPLICATION

This application claims the benefit of U.S. Provisional Application No. 60/365,262, filed Mar. 19, 2002.

### FIELD OF THE INVENTION

The present invention is related to a measuring instrument, especially to such a measuring instrument which will widely be used in businesses of interior decoration such as draperies, window covers and moldings, etc. By using this measuring instrument, we not only can take an accurate angle of a bay window or any corner of a room, but also we can get other many dimensions conveniently and directly.

### BACKGROUND OF THE INVENTION

With existing some tools such as a protractor, a tape measure, etc, we can take angles of the bay window or any corner of the room, also we can get the width of three walls of the bay window. However, it is unsatisfactory! For example, we want to mount draperies for the bay window. Without doubt, the width of the three draperies can't be equal to that of the three walls because of indispensable interval between the draperies and the walls. If they are equal, one rod of the draperies can't butts on another, but they intersect, so the draperies are not able to be hanged on the rods because it is impossible that two draperies intersect, and further the out end of the draperies likely project from the bay window. See FIG. 10a. It is not beautiful. It is obvious that the draperies must be narrower than the walls. We can calculate the width of the draperies with complex trigonometric function by the angles taken, but it is very difficult and inconvenient for most people. We need a good measuring instrument. The present invention is giving an ideal solution. Using the present invention, we not only can take the accurate angles of the bay window, but also we can easy get the width value of the draperies. Up to the present, it is not found that any other measuring instrument can do so directly.

### BRIEF SUMMARY OF THE INVENTION

A measuring instrument for bay windows is primarily comprised of a left wing 1 and a right wing 2, and the two wings are joined together by a rivet 17, and each of them can rotate around rivet 17, and each has a straight topside. There are three sets of scale line respectively for the angle, the width and the interval on a surface of the two wings. In which, the interval lines 5 is the most important, and they are a set of parallel lines parallel to the topside to indicate the interval to the topside. The two straight topsides can form an included angle by rivet 17 as a vertex. The two topsides and each pair of corresponding interval lines can align when the included angle is 180°, but each pair of the corresponding interval lines intersect when the included angle is less than 180°. Make width indicating line 16 pass through an intersection of some pair of corresponding interval lines, and it can just point out according width value. Objects and advantages of the present invention are: to provide a measuring instrument with which we not only can take an accurate angles of the bay windows or any corner of the room, but also we can easy get the length value (sometimes width value, such as draperies) of those straight lines parallel to the walls to form the included angle. It is very useful in the businesses of interior design and decoration.

### DRAWING FIGURES

In the drawings, closely related figures have the same number but different alphabetic suffixes.

FIG. 1a shows a left wing of the measuring instrument.

FIG. 1b is a section view of the left wing.

FIG. 2a shows an angle indicator.

FIG. 2b is a side view of the angle indicator.

FIG. 3a shows a right wing 2.

FIG. 3b is a side view of the right wing.

FIG. 4a shows a vernier.

FIG. 4b is a side view of the vernier.

FIGS. 4c and 4d show other forms of the vernier.

FIG. 5 shows assembly of the left wing with the angle indicator.

FIG. 6 shows assembly of the right wing with the vernier.

FIG. 7 shows assembly of the left wing and the angle indicator with the right wing and the vernier.

FIG. 8 shows how to operate the measuring instrument.

FIG. 9 shows how to measure a bay window with the measuring instrument.

FIG. 10a and FIG. 10b show the difference between using and not using the measuring instrument.

### REFERENCE NUMERALS IN DRAWINGS

1 left wing

2 right wing

3 angle indicator

4 vernier

5 interval lines

6 width scale

7 angle arc

8 180° overlapping line

9 arc channel

10 circular hole on left wing

11 circular hole on angle indicator

12 angle indicating line

13 platform

14 circular hole on right wing

15 groove

16 width indicating line

17 rivet

### DESCRIPTION OF THE PREFERRED EMBODIMENT

The measuring instrument for bay windows is composed of a left wing 1, a right wing 2, an angle indicator 3 and a vernier 4. All of these parts are made of a transparent material such as a transparent plastic.

We can find in FIG. 1a that left wing 1 is a rectangle, and it is stressed that the topside must be a straight edge. There is a circular hole 10 at upper right corner of left wing 1. A straight line to pass through the center of hole 10 is perpendicular to the straight topside of left wing 1. We call the straight line the 180° overlapping line 8.

A set of straight lines that run through from the left to the right are carved on the surface of left wing 1. All of these lines are parallel to the topside of left wing 1 and perpendicular to 180° overlapping line 8. These lines are called an interval line 5 that can indicate the interval between the drapery and the wall. Their scale values start from the topside of the wing as zero. To read easy, it is good to mark interval lines 5 with two colors alternately.

Width scales 6 are distributed along the topside, and the scale values start from the center of hole 10 as zero.

An arc that takes the center of hole 10 as its center is called an angle arc 7, and angle scale is arranged along the arc, and the value of 0° is carved on an imaginary line that passes through the center of hole 10 and is parallel to the topside, and the value of 90° is on 180° overlapping line 8.

There is an arc channel 9 on the back of left wing 1. The center of arc channel 9 is just the center of hole 10, and its radius is little shorter than the side of left wing 1. The angle included by arc channel 9 is 90°. FIG. 1b shows the section of arc channel 9 and left wing 1.

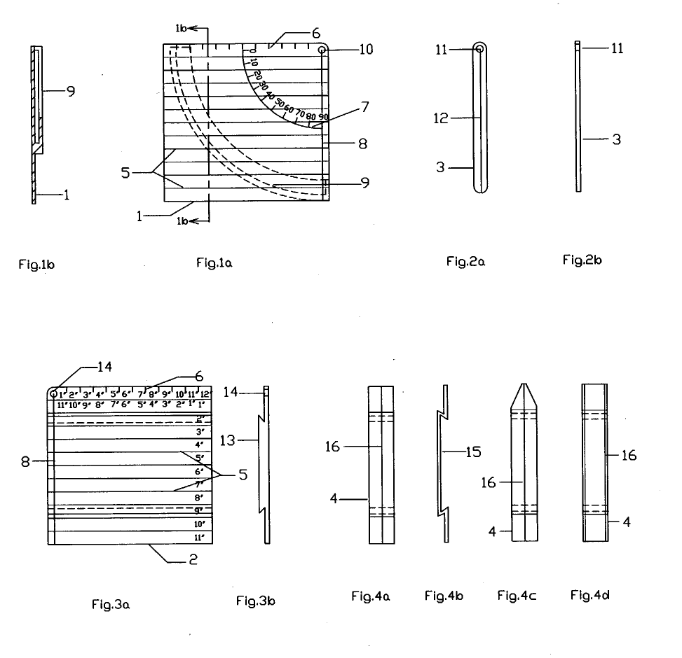

FIG. 2a shows angle indicator 3. A hole 11 is at an end of angle indicator 3, and the radius of hole 11 is the same as that of hole 10. A straight angle indicating line 12 passes through the center of hole 11 and runs through the middle of angle indicator 3. It is suggested to mark angle indicating line 12 with a bright color such as red. Angle indicator 3 is set up on the back of left wing 1. Its hole 11 and hole 10 of left wing 1 overlap and can be passed through by a rivet 17. Another end of angle indicator 3 should be inserted into arc channel 9. This end can free slide along arc channel 9 when angle indicator 3 rotates around rivet 17. See FIG. 5 for details.

FIG. 3a shows right wing 2. We can find that right wing 2 is similar to left wing 1. A set of interval lines 5 parallel to the topside and width scales 6 along the topside are printed on the surface of right wing 2. Width scales 6 are arranged in two rows, and the order of the two rows of the scales is reverse, and one starts from the center of a hole 14 as zero, and another starts from the right side of right wing 2 as zero. These interval lines are in correspondence with those of left wing 1 one by one. The differences between the two wings are as the follows:

There is not angle arc 7 on right wing 2. It is to avoid difficulty to read the overlapping angle scales. Hole 14 is at upper left corner, and also 180° overlapping line 8 perpendicular to the topside is lain on the left and go through the center of hole 14. The radius of hole 14 is the same as that of hole 10. There is no arc channel on the back of right wing 2, but a platform 13 bulges out from the front of right wing 2, and it goes through right wing 2 from the left to the right, and the upper side and the lower side of platform 13 are all parallel to the topside of right wing 2. From FIG. 3b, we find that the flank of platform 13 is an inverted trapezoid.

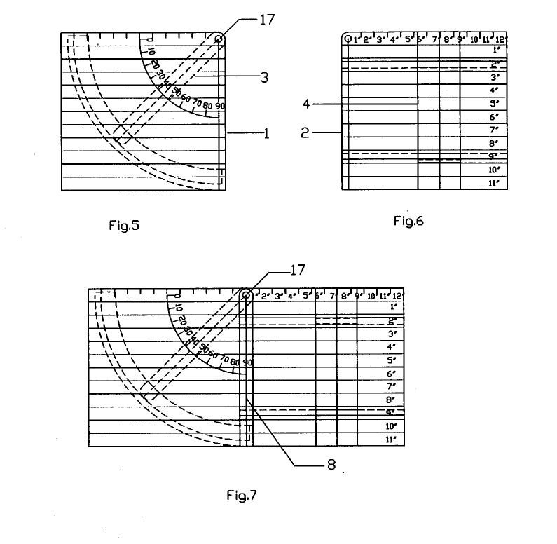

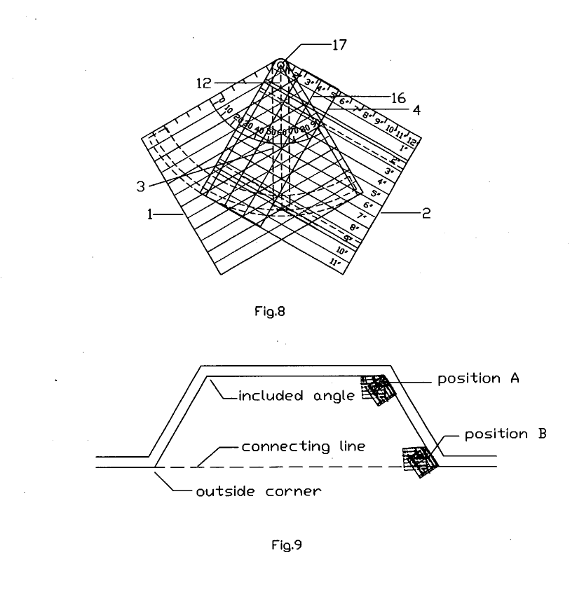

FIG. 4a shows rectangular vernier 4. The height of vernier 4 is equal to that of right wing 2 or at least to align its upperside and the topside of right wing 2. A straight width indicating line 16 goes through the middle of vernier 4 from the top to the bottom. Like angle indicating line 12 width indicating line 16 should be marked with a bright color too. Vernier 4 can't be too wide, if too wide vernier 4 may overstep the edge of right wing 2, and is likely obstructed by the wall when width indicating line 16 reaches the width scale of 0 or near 0. A proper width of vernier 4 can make width indicating line 16 go through the width scale of 0 or near 0 without obstruction.

Of course we may either cut the top of vernier 4 into an arrow or mark separately width indicating line 16 near two upright edges of vernier 4 to solve the problem. See FIGS. 4c and 4d.

The bulge at the waist of vernier 4 makes a groove 15 on the back of vernier 4. FIG. 4b shows that groove 15 is an inverted trapezoid too. And the trapezoid of groove 15 and that of platform 13 match in the shape and the size. We can push vernier 4 into right wing 2 along platform 13, so platform 13 falls into groove 15 of vernier 4. See FIG. 6. Under this condition, platform 13 is actually a track along which vernier 4 can slide smoothly.

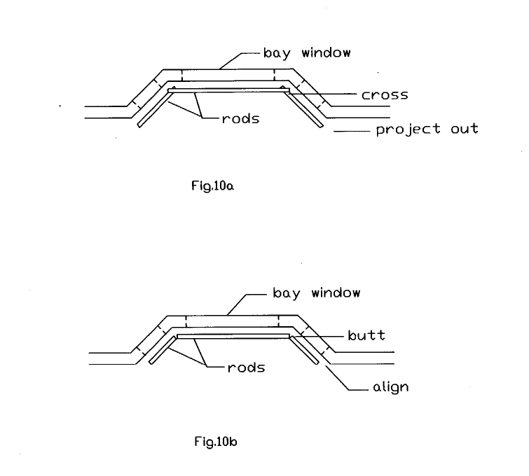

We can rivet right wing 2, left wing 1 and angle indicator 3 together with rivet 17 going through hole 14, hole 10 and hole 11. See FIG. 7 for details. Right wing 2, left wing 1 and angle indicator 3 can rotate around rivet 17. When 180°overlapping line 8 of left wing 1 and that of right wing 2 overlap, the angle included by the two wings is 180°, and at this time the topsides of the two wings should be on the identical straight line, and it aligns corresponding each pair of interval lines 5 of the two wings.

Operation of the Invention

Now we illustrate with FIG. 8 and FIG. 9 how this measuring instrument works. Suppose an included angle of a bay window is 120°. We want to mount the draperies for the bay window with 6 inches of the interval to the wall. What is the width of the rods of the draperies? Now we can get answers easy by using the invention.

Let us hold the measuring instrument horizontally, and train the angle with rivet 17 of the measuring instrument on the vertex of the included angle of the bay window (at the position A of FIG. 9), and then rotate the two wings to nestle the topside of every wing on the walls. We find that each of interval lines 5 of the two wings intersect, and the intersections of every pair of the corresponding interval lines of the two wings such as the intersection of the 1″-interval line, the intersection of the 2″-interval lins, . . . fall all into an identical straight line. Rotate angle indicator 3 for angle indicating line 12 to go through all of the intersections, in this way angle indicating line 12 and angle arc 7 intersect, and the angle value of the intersection is just a half of the included angle of the bay window. The semi-angle is very useful in the business of the interior decoration. For example, we often use the semi-angle when we saw a board for a valance of the bay window.

In order to get the width of the draperies we should move vernier 4 along platform 13 for width indicating line 16 to go through the intersection of the 6″-interval lines, and in this way width indicating line 16 and the topside of right wing 2 intersect, and the intersection shows a value of the subtrahend-1 in the first row of width scales 6. And then keep the included angle of the two wings and move the measuring instrument out to make the upper right angle of right wing 2 against the outside corner of the bay window (at the position B of FIG. 9), and a imaginary line connecting two outside corners of the bay window and the 6″-interval line intersect. Move vernier 4 for width indicating line 16 to go through the intersection, so the subtrahend-2 is shown in the second row of the width scales. The width of the wall minus the subtrahend-1 and the subtrahend-2 is just the width of the drapery. The values of the subtrahend-1 and the subtrahend-2 are all 3.4″ by chance in this example. The two included angles of the bay window are equal generally. For the middle drapery we must subtract the double subtrahend-1 s from the width of the middle wall because it relates to the two included angles.

If the interval to the wall is not 6 inches, but 3 inches, we should move vernier 4 for width indicating line 16 to go through the intersection of the 3″-interval lines, and then width indicating line 16 should indicate the subtrahend-1 to be 1.7″.

As stated above, we can get accurate sizes of the draperies for the bay window by using the measuring instrument. So, we can make a drapery butt on another, and we can also align the out ends of the draperies and the outside walls of the bay window. See FIG. 10b.

### BRIEF OF THE PRIMARY EMBODIMENT

As a primary embodiment, the measuring instrument is composed of only left wing 1, right wing 2 and rivet 17 without any other element such as angle indicator 3, vernier 4, arc channel 9 and platform 13, etc, and rivet 17 joins the two wing together. And Interval lines 5, width scale 6, angle arc 7 and 180° overlapping line 8 having the same properties as state above are shown on the surface of the wings in the same way. Instead of with angle indicator 3 and vernier 4, we can also get angle value and width value with a common straight ruler to pass through the intersect(s) required.

I claim:

1. A measuring instrument comprising:
a) two flat thin bodies of material, each having a predetermined shape with at least one straight edge, and each having a identical set of parallel lines parallel to said straight edge to show an interval to said straight edge on a surface of said bodies of material, and
b) means for joining said bodies of material together and said bodies of material can rotate around said means.

2. The measuring instrument of claim 1 wherein a width scale along said straight edge should be shown on said surface of at least one of said bodies of material.

3. A measuring instrument comprising:
a) two flat thin bodies of material, each having a predetermined shape with at least one straight edge, and each having a identical set of parallel lines parallel to said straight edge to indicate the interval to said straight edge on a surface of said bodies of material, and each having one circular hole, and
b) an object having a predetermined shape fitting said circular hole running through the said circular holes to join said bodies of material together and said bodies of material can rotate around said object.

4. The measuring instrument of claim 3 wherein at least one between said bodies of material has a width scale along said straight edge and/or an angle scale around said circular hole on said surface thereof.

5. The measuring instrument of claim 3 further including a long bar for indicating width having predetermined shape to indicate width value.

6. The measuring instrument of claim 3 further including means for joining said bar for indicating width to one between said bodies of material so as to be able to lead said bar for indicating width to slide along it.
